(19) United States
(12) Patent Application Publication
(10) Pub. No.: US 2026/0016583 A1
(43) Pub. Date: Jan. 15, 2026

(54) ULTRASONIC SENSOR UNIT

(71) Applicant: Robert Bosch GmbH, Stuttgart (DE)

(72) Inventors: Stevens Wang, Stuttgart (DE); Kartik Hanamasagar, Bengaluru (IN); Pascal Sylvain Meysonnat, Stuttgart (DE); Daniel Ebert, Rutesheim (DE); Juergen Schmidt, Sindelfingen (DE); Tom Reimann, Bissingen An Der Teck (DE)

(21) Appl. No.: 19/257,680

(22) Filed: Jul. 2, 2025

(30) Foreign Application Priority Data
Jul. 12, 2024 (DE) 10 2024 206 589.7

(51) Int. Cl. G01S 7/539; G01S 15/931

(52) U.S. Cl. CPC G01S 7/539; G01S 15/931

(57) ABSTRACT

An ultrasonic sensor unit. The ultrasonic sensor unit includes a first ultrasonic element and a logic unit, wherein the first ultrasonic element is configured to emit and/or receive at least one ultrasonic wave, wherein the logic unit is configured to generate an echo signal and a trace signal based on the at least one emitted and/or received ultrasonic wave, wherein the logic unit is configured to predict at least one further ultrasonic wave and a further echo signal based on the echo signal and the trace signal using a Kalman filter, wherein the logic unit is configured to assign the further ultrasonic wave, the further echo signal and/or the further trace signal to the emitted ultrasonic wave, the echo signal and/or the trace signal by means of a Kuhn-Munkres algorithm.

### FIELD

The present invention relates to an ultrasonic sensor unit and a vehicle.

### BACKGROUND INFORMATION

There are currently a large number of different solutions for utilizing ultrasonic signals in the automotive sector. Due to the increasing number of ultrasonic sensors and the higher quality and reliability requirements for ultrasonic sensor technology in the automotive sector, there is a continuously growing demand for innovative and robust ultrasonic sensor units.

Continuous weight reduction in the automotive sector to reduce consumption and increasing competition are putting pressure on costs, which results in a greater demand for cheaper and more efficient vehicle components.

### SUMMARY

An ultrasonic sensor unit according to the present invention may have the advantage over the related art that the robustness of the ultrasonic measurement values is significantly improved and can be more easily adapted to changes in the surroundings of the ultrasonic sensor unit. It is an efficient tracking system that enables streamlined and systematic processing of the sensor data, which leads to more precise and reliable predictions and assignments. This approach improves the robustness of the system and makes it more adaptable to changes in the surroundings or the number of objects being tracked.

This may be achieved according to an example embodiment of the present invention in that the ultrasonic sensor unit comprises a first ultrasonic element and a logic unit, wherein the first ultrasonic element is configured to emit and/or receive at least one ultrasonic wave, wherein the logic unit is configured to generate an echo signal and a trace signal based on the at least one emitted and/or received ultrasonic wave, wherein the logic unit is configured to predict at least one further ultrasonic wave and a further echo signal for a further trace signal based on the echo signal and/or the trace signal by means of a Kalman filter, wherein the logic unit is configured to assign the further ultrasonic wave, the further echo signal and/or the further trace signal to the emitted ultrasonic wave, the echo signal and/or the trace signal by means of a Kuhn-Munkres algorithm.

In other words, the ultrasonic sensor unit can be used to carry out a data documentation that combines the Kalman filter and the Hungarian algorithm or Kuhn-Munkres algorithm in order to acquire echo data and link them within the ultrasonic system. For this purpose, it is in particular possible to use five main steps; in particular predicting, linking, updating, initializing and evaluating. The prediction step can preferably use the

Kalman filter to predict the measured values for a next time period, for example a frame. In the association step, the Hungarian algorithm or Kuhn-Munkres algorithm can be used to link the predicted data with the current measurement data in the current time period; for example within a suitable matching window. In an updating step, filter parameters of the Kalman filter can then be updated, in particular at the same time as an observer that uses covariance, to provide a matching window and other needed parameters for the next measurement cycle. Due to an imbalance in the number of inputs for traces and for incoming echoes, the traces can be validated without linking them to a new echo, in particular for the purpose of freeing up memory space for new data. If the echoes cannot be linked to an already existing trace, a new trace can be initialized, which can develop a new history. The echo signal can preferably be a data input or a plurality of data inputs based on an ultrasonic wave that was emitted and received by the same ultrasonic element, or an ultrasonic wave that was emitted by a first ultrasonic element and received by a second ultrasonic element. The trace signal can further preferably in particular be a trace or the like, which can in particular include a plurality of data inputs.

Preferred further developments of the present invention are disclosed herein.

According to an example embodiment of the present invention, the logic unit is preferably configured to update the Kalman filter based on the assigned further ultrasonic wave, the assigned further echo signal and/or the assigned further trace signal in order to create a suitable window and at least one adjusted parameter for a further measurement.

An advantage of this example embodiment of the present invention is that measurement errors or the like can be detected and excluded from further processing. The suitable window preferably comprises a range in which the measured values for the next further measurement can lie. The Kalman filter can be used to estimate the state of a system by combining measurements of the system with state predictions. The Kalman filter is particularly useful in systems with noisy or incomplete measurements and when there is uncertainty about how the system will evolve over time. The main application of the Kalman filter in this context is to predict the next echo distance based on a series of stored echoes in a trace.

A number of inputs into the assigned further echo signal is further preferably unequal to a number of inputs into the assigned further trace signal, wherein the logic unit is configured to assign an input into the assigned further echo signal to a new trace signal if the input into the echo signal cannot be assigned to the assigned further trace signal.

An advantage of this example embodiment is that an independent decision, whether the received or measured ultrasonic value belongs to a trace or whether a new trace should be formed, is made in the ultrasonic sensor unit.

The “assignment” step can be used to assign exactly one echo to each trace and vice versa. After the prediction step, each trace is assigned a predicted value for the next echo distance. The predictions can then be compared to the incoming echoes and the difference calculated. This difference can be used to calculate the costs for each pair. Assuming there are M traces on the x-axis and N echoes on the y-axis that need to be assigned to each trace, the costs w(x, y) can be determined for each pair (trace, echo). Preferably, all of the assignments can be completed to minimize the total costs of the cost table W(x, y).

For example, a trace may not be assigned to any echo or vice versa. This may mean that the trace was not updated with new information in this measurement cycle. This results in two challenges: first, the local minimum may not be the global minimum of the costs, and second, the matrix may be asymmetrical.

To solve this assignment problem with minimal cost, a Kuhn-Munkres algorithm (also known as the Hungarian algorithm) with a polynomial time complexity can be used. This algorithm can work by iteratively finding a set of complementary paths in a weighted bipartite graph.

The cost matrix for the Hungarian algorithm is preferably prepared with the complexity. The minimum problem is preferably converted to a maximum problem: W(x, y)=−W(x, y). The cost matrix W is balanced by filling the rows or columns with a standard cost limit value, e.g. the maximum invalid costs defined as a positive number. The result of this step is a balanced N×N matrix with covered costs. The algorithm works by finding a maximum match in a bipartite graph, wherein one set x of nodes represents the current echoes and the other set y represents the traces.

The above-described process of assigning assignments is continued until all of the nodes are assigned, which means that the number of assignments can correspond to the size of the cost matrix. When this occurs, a path with the minimum total costs is preferably found, in which case each element in the line assigned to exactly one element in the corresponding column. This can ensure that each echo and each trace are assigned to exactly one counterpart. Since the cost matrix is balanced at the beginning of the algorithm, there may be echoes that cannot be associated with a trace because the number of traces is less than the number of echoes and vice versa.

According to an example embodiment of the present invention, the logic unit preferably comprises at least one Kalman filter observer, wherein the Kalman filter observer is configured to adjust at least one output value of the Kalman filter if the output value of the Kalman filter deviates by a predetermined amount from the ultrasonic wave, the echo signal and/or the trace signal.

An advantage of this example embodiment of the present invention is that the observer can be used to further improve the results of the Kalman filter and thus further improve the accuracy of the overall system.

In practical application of the Kalman filter, it can be difficult to determine and adjust the accuracy of the assignments in real time, and also to analyze the performance of the system based on the assignments of the recorded measurements. To solve this problem, an observer can be used to monitor the states of the system. The observer can analyze the output of the filter and compare it with the actual measurements. If deviations in the estimates of the filter are detected, the observer can make necessary adjustments to the parameters of the filter to improve its accuracy and reliability.

When the filter is working correctly, the measurement noise is preferably white noise with a mean of zero. The consistency of the filter can therefore be checked by preferably applying the credibility assessment to the a posteriori error covariance and the credibility assessment to the innovation covariance.

According to an example embodiment of the present invention, the elements of the innovation covariance matrix can preferably be used to check the consistency of the output of the Kalman filter. If the size of the innovation relative to the innovation covariance matrix is too large, this may be an indication that the filter is not functioning properly and may need to be adjusted. The innovation covariance matrix is also a good indicator for the adjustment of the assignment window for the association step. The first element of the innovation covariance matrix can preferably be used to filter out uncorrelated data, so that preferably only relevant data are considered for the association step. This can improve the accuracy and efficiency of the algorithm.

The logic unit is preferably configured to update at least one operating parameter of the observer based on the assigned further ultrasonic signal, the assigned further echo signal and/or the assigned further trace signal.

When an echo is assigned to a trace, it is preferably included in the stored echo list of the trace. This can trigger an update of the Kalman filter for this trace. The process of updating the Kalman filter can involve integrating the predicted states with the newly measured states, namely the updated echo distance and the slope or the first time derivative of the distance which can result from the addition of the new echo to the trace. The state control is preferably also updated by calculating the second derivatives of the most recent echo distances. The updated state estimation and covariance matrix are preferably then used as the basis for the next prediction step in the Kalman filter algorithm.

An advantage of this embodiment of the present invention is that the accuracy of the observer can be further improved, and in particular a synergistic effect between the observer and the Kalman filter is created, which can further improve the assignment accuracy and, consequently, the measurement accuracy of the sensor unit.

Updating the at least one operating parameter of the observer preferably includes updating a covariance matrix.

An advantage of this embodiment of the present invention is that a variety of components can be taken into account to improve the operating parameter of the observer.

The logic unit is further preferably configured to ascertain a difference between the echo signal or the trace signal and the further echo signal or the further trace signal, wherein the logic unit is configured to determine a value for each pair of values of the further echo signal and the further trace signal based on said difference.

An advantage of this embodiment of the present invention is that the difference that forms can be used to increase the comparability of the ultrasonic sensor values.

The logic unit is preferably configured to minimize a total value by means of the Kuhn-Munkres algorithm, wherein the total value is a sum of a plurality of values for each pair of values, wherein the logic unit is configured to assign the further ultrasonic wave, the further echo signal and/or the further trace signal to the ultrasonic wave, the echo signal or the trace signal based on the total value and the Kuhn-Munkres algorithm.

An advantage of this embodiment of the present invention is that a trip can be determined with minimal total costs, which ensures that each echo and each trace is associated with exactly one counterpart.

The ultrasonic sensor unit preferably comprises a second ultrasonic sensor element, wherein the logic unit is configured to assign a second echo signal acquired by the second ultrasonic sensor element to the further trace signal by means of the Kuhn-Munkres algorithm.

An advantage of this embodiment of the present invention is that a plurality of ultrasonic sensors, which can be disposed all around a car, for example, are used to further improve the accuracy of the ultrasonic sensor unit.

A further aspect of the present invention relates to a vehicle comprising an ultrasonic sensor unit as described above and in the following.

### BRIEF DESCRIPTION OF THE DRAWINGS

Embodiment examples of the present invention are described in detail in the following with reference to the figures.

FIG. 1 show an ultrasonic sensor unit according to one example embodiment of the present invention.

FIGS. 2 to 4 show diagrams illustrating the operation of the ultrasonic sensor unit according to one example embodiment of the present invention.

FIGS. 5 and 6 show block diagrams illustrating the operation of the ultrasonic sensor unit according to one example embodiment of the present invention.

FIG. 7 shows a simulation view of a vehicle comprising the ultrasonic sensor unit according to one example embodiment of the present invention.

FIGS. 8 and 9 show diagrams illustrating the operation of an ultrasonic sensor unit according to one example embodiment of the present invention.

FIG. 10 shows a vehicle according to one example embodiment of the present invention.

### DETAILED DESCRIPTION OF EXAMPLE EMBODIMENTS

All same elements, units and/or steps are preferably provided with the same reference signs in all of the figures.

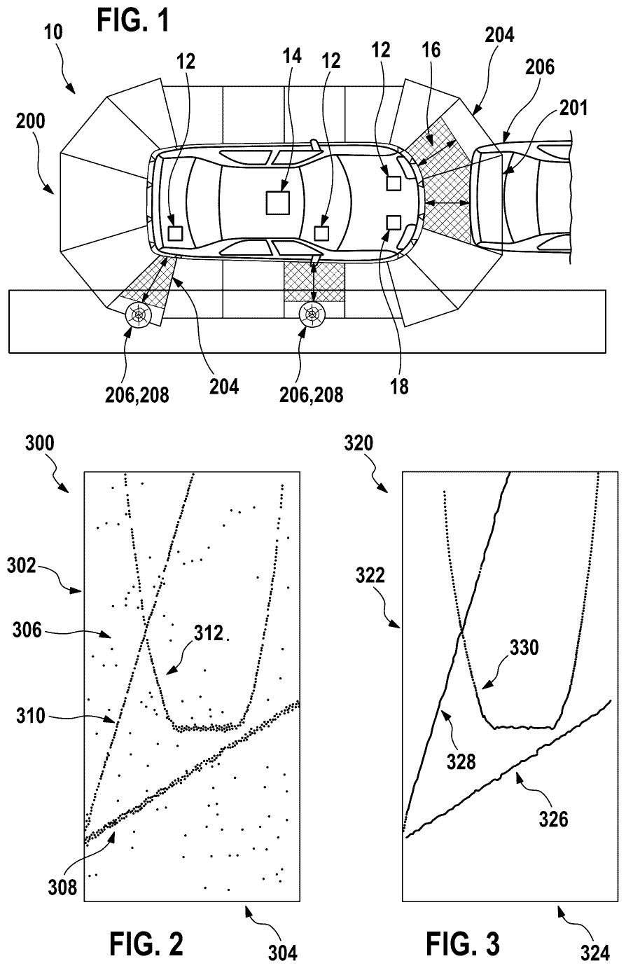

FIG. 1 shows an ultrasonic sensor unit 10 according to one embodiment. The ultrasonic sensor unit 10 comprises a first ultrasonic element 12 and a logic unit 14, wherein the first ultrasonic element 12 is configured to emit and/or receive at least one ultrasonic wave 16, wherein the logic unit 14 is configured to generate an echo signal and a trace signal based on the at least one emitted and/or received ultrasonic wave 16, wherein the logic unit 14 is configured to predict at least one further ultrasonic wave, a further echo signal and/or a further trace signal based on the echo signal and the trace signal by means of a Kalman filter, wherein the logic unit 14 is configured to assign the further ultrasonic wave, the further echo signal and/or the further trace signal to the emitted ultrasonic wave, the echo signal and/or the trace signal by means of a Kuhn-Munkres algorithm.

As shown in FIG. 1, the ultrasonic sensor unit is preferably disposed in a vehicle 100. The ultrasonic sensor unit can preferably comprise a logic unit 14, which can be embodied separately or in one piece with an ultrasonic element 12. The ultrasonic sensor unit 10 can further preferably comprise a second ultrasonic element 18 which can in particular receive an ultrasonic wave 16 emitted by the first ultrasonic element 12. As illustrated in FIG. 1, the ultrasonic elements form respective fields of view 200; an obstacle 206 can in particular be detected in a section 204 which is monitored by the first ultrasonic element 12, for instance. The obstacle 206 can further preferably also be detected in a second section 204, which is monitored by the second ultrasonic sensor element 18, for example. The obstacle 206 can also be a tree 208, for instance.

FIG. 2 shows a diagram 300 illustrating the operation of the ultrasonic sensor unit 10 according to one embodiment. The diagram 300 preferably includes a first axis 302 and a second axis 304. As can be seen in FIG. 2, a plurality of traces 306 are plotted in the diagram 300. A respective ultrasonic measurement can be assigned to a first trace 308, a second trace 310 or a third trace 312, for example.

FIG. 3 shows a diagram 320 illustrating the operation of the ultrasonic sensor unit 10 according to one embodiment. The diagram 320 preferably includes a first axis 322 and a second axis 324. As can be seen in the diagram 320, the ultrasonic measurement values can in particular be combined to form a curve 326, a second curve 328 and a third curve 330.

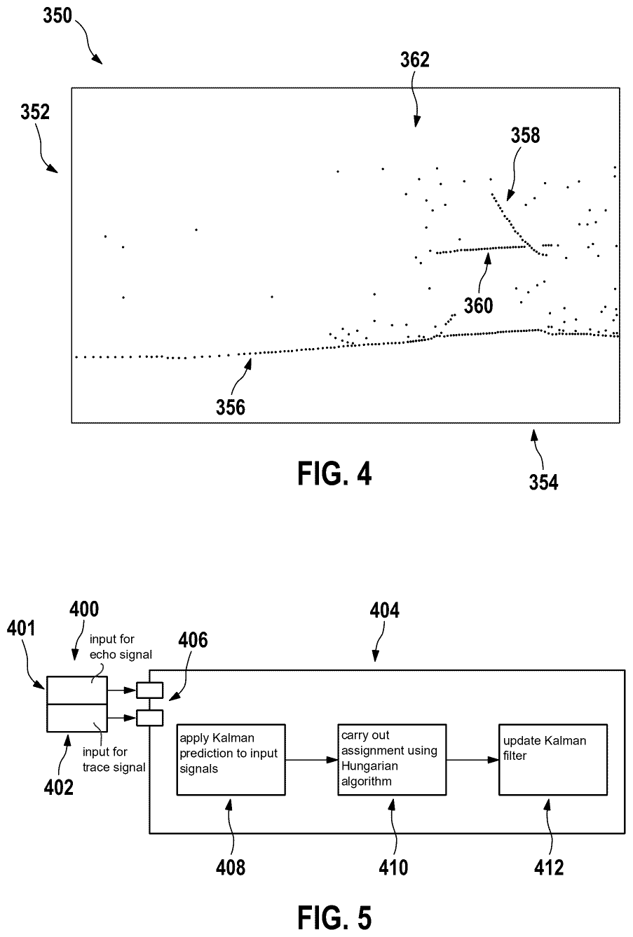

FIG. 4 shows a diagram 350 illustrating the operation of the ultrasonic sensor unit 10 according to one embodiment. The diagram 350 preferably includes a first axis 352 and a second axis 354. A plurality of measured values 362 can preferably be plotted on the diagram. The ultrasonic sensor unit 10 is preferably configured to form a first trace 356 based on the plurality of measured values 362. The ultrasonic sensor unit 10 can further preferably also acquire a second trace 358 and a third trace 360.

FIG. 5 shows a block diagram 400 illustrating the operation of the ultrasonic sensor unit 10 according to one embodiment. The diagram 400 preferably comprises two inputs, in particular an input for the echo signal 401 and an input for the trace signal 402. Preferably, an algorithm 404 can take over the further processing of the input signals in the converter 406. Preferably, a Kalman prediction step 408 can be applied to the input signals 406. Based on the prediction step 408, an assignment step can in particular be carried out using the Hungarian algorithm 410, which can in particular utilize the input signals 406. Further preferably, an updating step 412 of the Kalman filter can be carried out, which can in particular take into account the results of the Hungarian algorithm 410 and also the input signals 406.

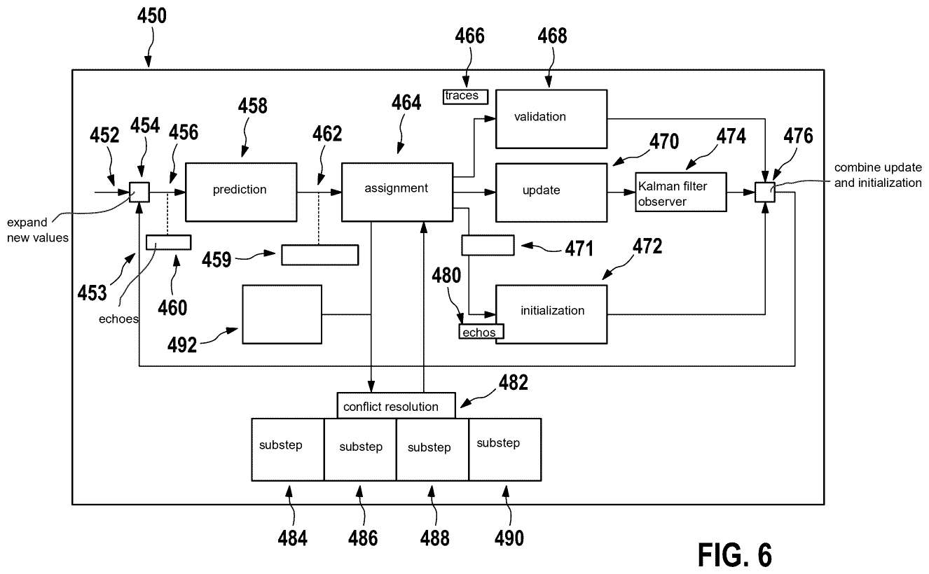

FIG. 6 shows a block diagram 450 illustrating the operation of the ultrasonic sensor unit 10 according to one embodiment. Preferably, new measured values 452 can be available for the ultrasonic sensor unit 10. In step 454, the new values 452 can in particular be expanded by existing values 453. The combination of the data in step 456, in particular with the echoes 460, can be used in the prediction step 458. Based on the updated values of the echo and the trace 464, these values can be fed into an assignment process 464 in step 462. This can be used to carry out a substep of conflict resolution 482 can occur in the association 464. In order to be able to assign a plurality of echo values to each trace, the step 482 can preferably include a plurality of substeps 484, 486, 488, 490. The traces 466 can be used to carry out a validation 468. The traces and the echoes 478 can further preferably be used to carry out an update 470. An initialization 472 can be carried out based on the association 464 using the echoes 480. A Kalman filter observer 474 can further preferably be applied based on the update 470. The results of the validation 468, the update 470 and the initialization 472 can be combined in step 476 to be able to form and store the existing trace data 453 and thus close the loop.

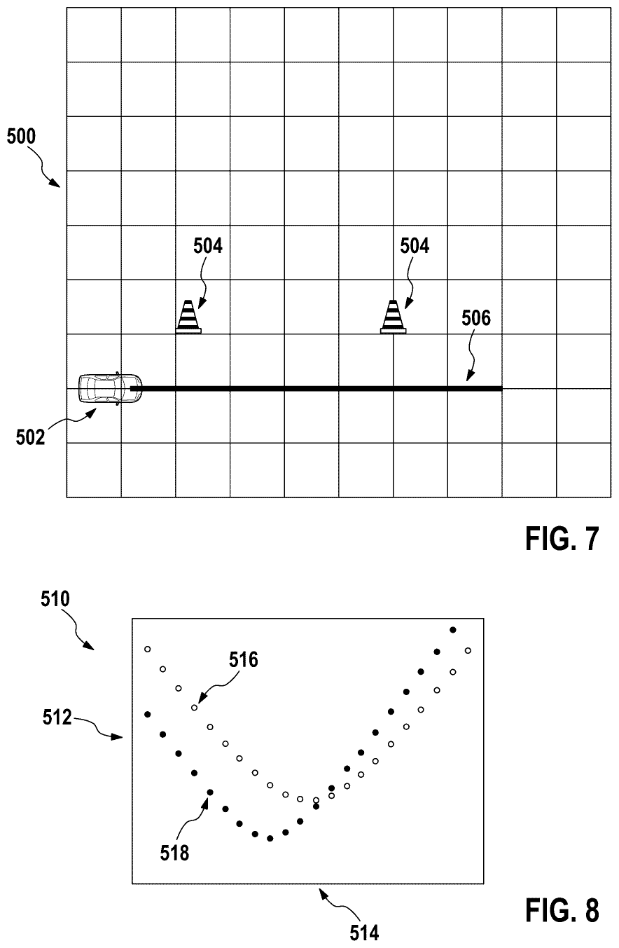

FIG. 7 shows a simulation view 500 illustrating the operation of the ultrasonic sensor unit 10 according to one embodiment. As shown in the simulation view 500, a vehicle 502 can emit an ultrasonic wave 506, wherein in particular obstacles 504 are simulated.

FIG. 8 shows a diagram illustrating the operation of the ultrasonic sensor unit 10 according to one embodiment. The diagram 510 includes a first axis 512, which in particular includes a distance of the echo, and a second axis 514, which includes a time signature. As shown in the diagram 510, a first curve 516 and a second curve 518 can be shown, wherein the ultrasonic sensor unit 10 is configured to add new measured values to the respective curve based on the Kalman filter and the Hungarian algorithm.

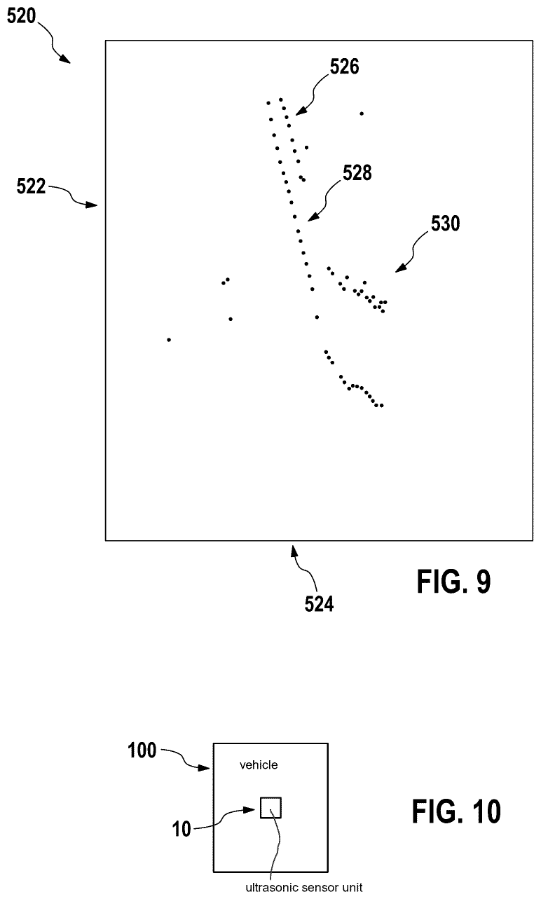

FIG. 9 shows a diagram 520 illustrating the operation of the ultrasonic sensor unit 10 according to one embodiment. The diagram 520 preferably includes a first axis 522 and a second axis 524. A plurality of measured values 530 are plotted in the diagram 520, and the ultrasonic sensor unit 10 is configured to identify a first curve 526 and a second curve 528.

FIG. 10 shows a vehicle 100 according to one embodiment. The vehicle 100 further preferably comprises an ultrasonic sensor unit 10 as described above and in the following.

1-10. (canceled)

11. An ultrasonic sensor unit, comprising:
a first ultrasonic element; and
a logic unit;
wherein the first ultrasonic element is configured to emit and/or receive at least one ultrasonic wave;
wherein the logic unit is configured to generate an echo signal and a trace signal based on the emitted and/or received at least one ultrasonic wave;
wherein the logic unit is configured to predict at least one further ultrasonic wave and a further echo signal for a further trace signal based on the echo signal and/or the trace signal using a Kalman filter;
wherein the logic unit is configured to assign the further ultrasonic wave, and/or the further echo signal. and/or the further trace signal to the emitted ultrasonic wave, and/or the echo signal and/or the trace signal, using a Kuhn-Munkres algorithm.

12. The ultrasonic sensor unit according to claim 11, wherein the logic unit is configured to update the Kalman filter based on the assigned further ultrasonic wave, and/or the assigned further echo signal and/or the assigned further trace signal to create a suitable window and at least one adjusted parameter for a further measurement.

13. The ultrasonic sensor unit according to claim 12, wherein:
a number of inputs into the assigned further echo signal is unequal to a number of inputs into the assigned further trace signal,
the logic unit is configured to assign an input into the assigned further echo signal to a new trace signal when the input into the echo signal cannot be assigned to the assigned further trace signal.

14. The ultrasonic sensor unit according to claim 12, wherein:
the logic unit includes at least one Kalman filter observer; and
the Kalman filter observer is configured to adjust at least one output value of the Kalman filter when an output value of the Kalman filter deviates by a predetermined amount from the ultrasonic wave, and/or the echo signal, and/or the trace signal.

15. The ultrasonic sensor unit according to claim 14, wherein the logic unit is configured to update at least one operating parameter of the Kalman filter observer based on the assigned further ultrasonic wave, and/or the assigned further echo signal and/or the assigned further trace signal.

16. The ultrasonic sensor unit according to claim 15, wherein the updating of the at least one operating parameter of the Kalman filter observer includes updating a covariance matrix.

17. The ultrasonic sensor unit according to claim 11, wherein:
the logic unit is configured to ascertain a difference between: (i) the echo signal or the trace signal and (ii) the further echo signal or the further trace signal,
the logic unit is configured to determine a value for each pair of values of the further echo signal and the further trace signal based on the difference.

18. The ultrasonic sensor unit according to claim 17, wherein:
the logic unit is configured to minimize a total value using the Kuhn-Munkres algorithm,
the total value is a sum of a plurality of values for each pair of values;
the logic unit is configured to assign the further ultrasonic wave and/or the further echo signal and/or the further trace signal to the ultrasonic wave, or the echo signal, or the trace signal based on the total value and the Kuhn-Munkres algorithm.

19. The ultrasonic sensor unit according to claim 11, wherein the ultrasonic sensor unit further comprises a second ultrasonic sensor element, wherein the logic unit is configured to assign a second echo signal acquired by the second ultrasonic sensor element to the further trace signal using the Kuhn-Munkres algorithm.

20. A vehicle, comprising:
an ultrasonic sensor unit, including:
a first ultrasonic element, and
a logic unit,
wherein the first ultrasonic element is configured to emit and/or receive at least one ultrasonic wave,
wherein the logic unit is configured to generate an echo signal and a trace signal based on the emitted and/or received at least one ultrasonic wave,
wherein the logic unit is configured to predict at least one further ultrasonic wave and a further echo signal for a further trace signal based on the echo signal and/or the trace signal using a Kalman filter,
wherein the logic unit is configured to assign the further ultrasonic wave, and/or the further echo signal. and/or the further trace signal to the emitted ultrasonic wave, and/or the echo signal and/or the trace signal, using a Kuhn-Munkres algorithm.
